(19) United States
(12) Patent Application Publication
(10) Pub. No.: US 2006/0249383 A1
(43) Pub. Date: Nov. 9, 2006

(54) Oxygen sensor assembly and holder therefor

(75) Inventors: Stephen H. Broy, Riverside, CA (US); Mann Nguyen, Walnut, CA (US)

Correspondence Address: KIRKPATRICK & LOCKHART NICHOLSON GRAHAM LLP, 535 SMITHFIELD STREET, PITTSBURGH, PA, 15222, US

(73) Assignee: Teledyne Technologies Incorporated

(21) Appl. No.: 11/124,839

(22) Filed: May 9, 2005

(51) Int. Cl. G01N 27/26

(52) U.S. Cl. 204/424

(57) ABSTRACT

A gas sensor assembly comprising a trace oxygen sensor is disclosed. The sensor includes a sensor housing and a connecting portion attached to the sensor housing defining a passageway for introducing a gas stream to the sensor housing.

### TECHNICAL FIELD OF THE INVENTION

The present invention relates generally to a gas sensor assembly comprising a trace oxygen sensor. The gas sensor assembly may further comprise a sensor holder configured to removeably engage a connecting portion of the trace oxygen sensor.

### BACKGROUND

FIG. 1a illustrates a cross-sectional view of a conventional oxygen sensor 5 such as, for example, a Teledyne Analytical Instruments' B-2C oxygen sensor sold by Teledyne Analytical Instruments, City of Industry, Calif. The sensor 5 may be used in a trace oxygen analyzer and capable of sensing oxygen concentrations in a range of 0-1 parts per million (ppm). As used herein, “trace oxygen analyzer” refers to an oxygen analyzer capable of measuring oxygen in concentrations from 0 to about 1,000 ppm. The sensor 5 includes a cathode 10 and an anode 15 sealed in a sensor housing 20 filled with appropriate electrolyte solution. The sensor housing 20 is designed to be received into a sensor canister 80, as discussed below in connection with FIG. 2, and is typically characterized by a cylindrical geometry with generally coaxial internal and external walls. A resilient insulating material, such as, for example, a thermoplastic material, is normally used to fabricate the sensor housing 20.

The sensor housing 20 includes a first end 25 defining a first opening 30 and a second end 35 defining a second opening 40. The first opening 30 receives an entering stream of gas to be sensed via a thin sensing membrane 45. As illustrated in FIG. 1 a, the first opening 30 is located within a recessed portion 50 of the first end 25 and centrally spaced relative to an external wall 55 of the sensor housing 20. The second opening 40 is positioned opposite the first opening 30 and is defined by the external wall 55 of the sensor housing 20. The second opening 40 is of a size and geometry suitable for receiving a back membrane 60 and a printed circuit board 65. The back membrane 60 allows for expansion and contraction of the electrolyte solution and is sealed to the sensor housing 20 using known sealing means. The back membrane 60 is typically fabricated from a suitably resilient material such as, for example, a thermoplastic material. The height of the second opening 40 is substantially equal to the total thickness of the back membrane 60 and the printed circuit board 65 so that a surface of the printed circuit board 65 is substantially flush with an edge of the sensor housing 20 after being placed over the back membrane 60 and sealed thereto.

FIG. 1b illustrates the sensor 5 of FIG. 1a as viewed from the first end 25 thereof. The first end 25 of the sensor housing 20 includes an annular-shaped rim portion 75 having an internal diameter defined by a peripheral edge of the recessed portion 50 and an external diameter defined by a peripheral edge of the external wall 55 of the sensor housing 20.

FIG. 1c illustrates the sensor 5 of FIG. 1a as viewed from the second end 35 thereof. The circuit board 65 includes concentric metallic contact rings 70a-b. The metallic contact rings 70a-b are electrically connected to the cathode 10 and anode 15, respectively, and function as electrical contacts for interfacing the sensor 5 with a sensing circuit (not shown). The metallic contacts rings 70a-b typically include a highly conductive material such as, for example, gold, silver, or copper, for minimizing contact resistance with corresponding electrical contacts contained in a conventional sensor canister 80 discussed below in connection with FIG. 2.

During operation, oxygen contained in the gas stream diffuses into the first opening 30 via the sensing membrane 45. Reduction of the oxygen at the cathode 10 causes a current signal to flow from the cathode 10 to the anode 15 through the sensing circuit connected to the metallic contact rings 70a-b. The magnitude of the current signal is proportional to the rate of oxygen reduction and is measured by the sensing circuit to generate an oxygen concentration output. Materials suitable for the cathode 10 and the anode 15, the composition of the electrolyte solution, and the electrochemical reactions that cause the current signal to flow are described in U.S. Pat. No. 6,524,740, which is incorporated herein it its entirety.

FIG. 2 illustrates a cross-sectional view of a conventional canister-type sensor holder 80, or “sensor canister”, that is typically used to contain the sensor 5 of FIGS. 1a, 1b, and 1c in a conventional trace oxygen analyzer. Such sensor canisters 80 are used in trace oxygen analyzers to ensure accurate measurements at the ppm level. The sensor canister 80 includes a cavity portion 85 of a size and geometry suitable for receiving and containing the gas sensor 5. Typically, the sensor canister 80 has a cylindrical geometry with generally coaxial internal and external walls. The sensor canister 80 may be fabricated from a non-porous material, such as, for example, a thermoplastic material or stainless steel, that is capable of preventing entry of ambient oxygen into the sensor 5. The cavity portion 85 of the sensor canister 80 is sized slightly larger than the gas sensor 5 to provide adequate gas flow around the sensor housing 20. A cap portion 90 of the sensor canister 80 is configured to securably engage the cavity portion 85 and to sealably encapsulate the gas sensor 5 therein. The cavity portion 85 includes a gas supply inlet 95 and a gas supply outlet 100 for receiving and exhausting the gas stream, respectively. The cavity portion 85 further includes electrical contacts (not shown) on an inner top surface thereof for providing an electrical connection with the metallic contact rings 70a-b of the gas sensor 5.

The use of the sensor canister 80 in conventional trace oxygen analyzers has traditionally been attributed to a need to prevent ingress of ambient oxygen through the sensor housing 20 and a need to provide thermal stability to the sensor 5 during its operation. Exposure of the sensor 5 to ambient oxygen and/or temperature fluctuations may reduce the accuracy of the oxygen concentration readings. These cited needs have typically dictated that the sensor canister 80 must entirely encapsulate the sensor 5 to prevent ingress of ambient oxygen and be of a mass sufficient for insulating the sensor 5 from temperature fluctuations. The material and labor costs necessary to fabricate a sensor canister 80 meeting these design criteria, however, is substantial and represents a considerable portion of the manufacturing cost of a conventional trace oxygen analyzer.

A conventional percent oxygen analyzer does not require a sensor canister 80 because slight ingress of ambient oxygen and temperature fluctuations do not significantly affect the accuracy of oxygen concentration readings at the percent level. Therefore, a connecting-type sensor holder is typically used in conventional percent oxygen analyzers. A connecting-type sensor holder connects with only a portion of a percent oxygen sensor and is not intended to encapsulate the sensor or provide thermal stability thereto. Thus, the connecting-type sensor holder requires substantially less material and labor to fabricate compared to that of the sensor canister 80. Despite its lower cost, the connecting-type sensor holder has heretofore not been used in trace oxygen analyzers, as it was believed to unacceptably reduce the accuracy of trace oxygen readings by increasing ambient oxygen ingress and decreasing thermal stability.

### SUMMARY

This application discloses a gas sensor assembly including a trace oxygen sensor. According to various embodiments, the sensor may include a sensor housing and a connecting portion attached to the sensor housing. The connecting portion may define a passageway for introducing a gas stream to the sensor housing.

According to other various embodiments, the sensor may include a sensor housing and a gas exposure housing encapsulating the sensor housing such that the gas exposure housing and the sensor housing define a circulation cavity therebetween. The sensor may further include a connecting portion attached to the gas exposure housing and defining a passageway for introducing a gas stream to the circulation cavity and to the sensor housing.

This application further discloses a trace oxygen analyzer including a trace oxygen sensor and a sensing circuit. According to various embodiments, the sensor may include a sensor housing, a connecting portion attached to the sensor housing and defining a passageway for introducing a gas stream to the sensor housing, and an electrical connector adapted for communicating a current signal from the sensor to a conductor pair attached to the electrical connector.

According to other various embodiments, the sensor of the trace oxygen analyzer may include a sensor housing and a gas exposure housing encapsulating the sensor housing such that the gas exposure housing and the sensor housing define a circulation cavity therebetween. The sensor may further include a connecting portion attached to the gas exposure housing and defining a passageway for introducing a gas stream to the circulation cavity and to the sensor housing. The sensor may still further include an electrical connector adapted for communicating a current signal from the sensor to a conductor pair attached to the electrical connector.

Unless otherwise indicated, all numbers expressing a size, quantity, and so forth used in the present specification and claims are to be understood as being modified in all instances by the term “about.” Accordingly, unless indicated to the contrary, the numerical parameters set forth in the following specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, may inherently contain certain errors necessarily resulting from the standard deviation found in their respective testing measurements.

The reader will appreciate the foregoing details and advantages of the present invention, as well as others, upon consideration of the following detailed description of embodiments of the invention. The reader also may comprehend such additional details and advantages of the present invention upon making and/or using embodiments within the present invention.

### DESCRIPTION OF THE FIGURES

Various embodiments of the invention will be described by way of example in conjunction with the following figures, wherein:

FIG. 1a illustrates a cross-sectional view of a conventional oxygen sensor;

FIG. 1b illustrates the sensor of FIG. 1a as viewed from the first end thereof;

FIG. 1c illustrates the sensor of FIG. 1a as viewed from the second end thereof;

FIG. 2 illustrates a cross-sectional view of a conventional sensor canister typically used for containing the sensor of FIGS. 1a, 1b, and 1c in a conventional trace oxygen analyzer;

FIGS. 3a and 3b illustrate cross-sectional views of a gas sensor assembly, according to various embodiments;

FIG. 4 illustrates a cross-sectional view of a gas sensor assembly, according to various embodiments;

FIG. 5 illustrates a schematic diagram of trace oxygen analyzer, according to various embodiments; and

FIG. 6 illustrates a first oxygen concentration trendline obtained using a conventional trace oxygen analyzer and a second oxygen concentration trendline obtained using a trace oxygen analyzer comprising a gas sensor assembly according to an embodiment of the present invention.

### DESCRIPTION

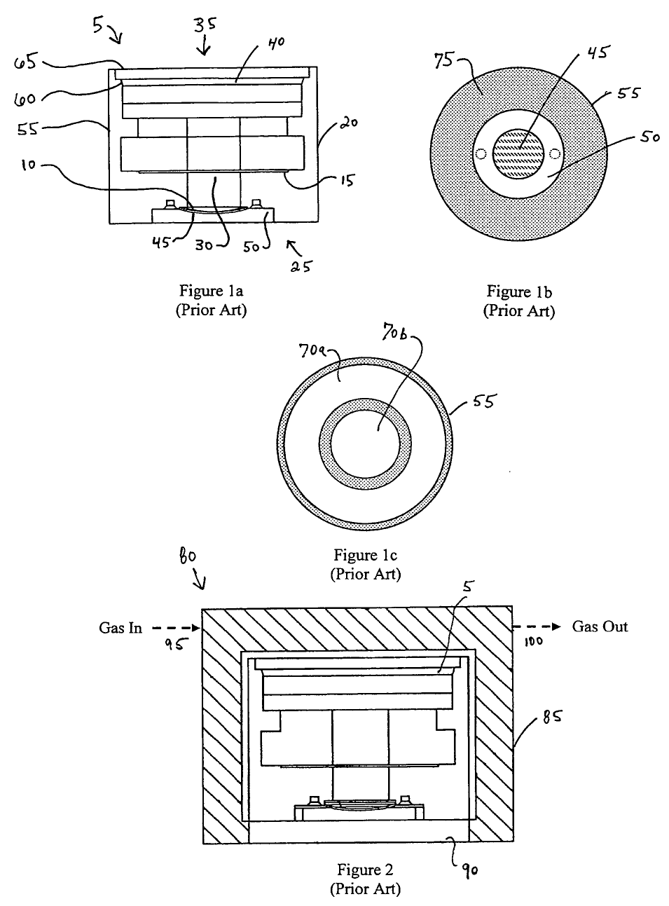

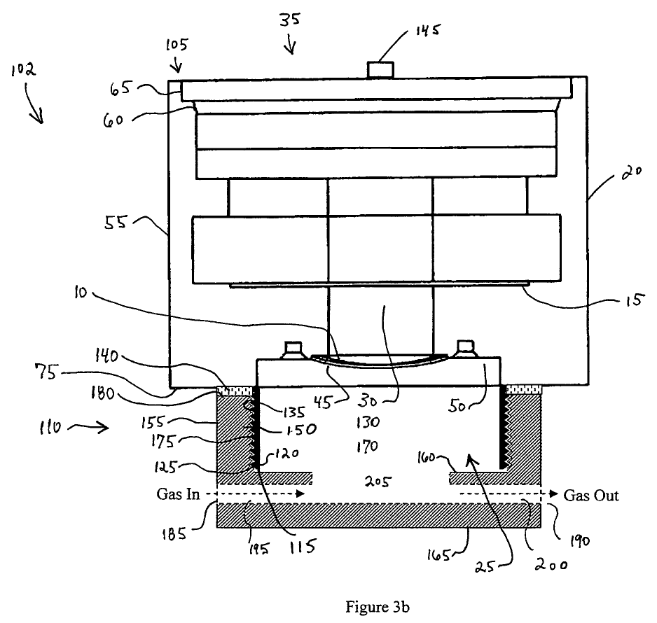

FIGS. 3a and 3b illustrate cross-sectional views of a gas sensor assembly 102, according to various embodiments. The sensor assembly 102 may comprise a trace oxygen sensor 105 having features and sensing capabilities identical those of the sensor 5 described above in connection with FIGS. 1a, 1b, and 1c. The trace oxygen sensor 105 may comprise a sensor housing 20, a connecting portion 115 attached to the sensor housing, a gasket 140, and an electrical connector 145. The sensor assembly 102 may further comprise a connecting-type sensor holder 110 (hereinafter “sensor holder”) for removably engaging a portion of the trace oxygen sensor 105. For purposes of clarity, FIG. 3a depicts the trace oxygen sensor 105 and the sensor holder 110 separately, and FIG. 3b depicts the trace oxygen sensor 105 and sensor holder 110 as engaged.

In one embodiment, the connecting portion 115 may be attached to and extend outward from a first surface on the rim portion 75 of the sensor housing 20 in a perpendicular fashion and be centrally positioned relative to the external wall 55 of the sensor housing 20. According to various embodiments, the connecting portion 115 may have a cylindrical geometry and comprise generally coaxial internal and external walls 120, 125, respectively. The internal wall 120 of the connecting portion 115 may define a passageway 130 axially aligned with the first opening 30 of the sensor housing 20 for introducing a gas stream received therethrough into the first opening 30 via the sensing membrane 45. The passageway 130 may have a diameter equal to that of the recessed portion 50 such that a smooth transition is provided therebetween. According to various embodiments, the connecting portion 115 may comprise a first means 135 for engaging. As described below, the sensor holder 110 may comprise a second means 175 for removably engaging the first engagement means 135 of the connecting portion 115. The first engagement means 135 of the connecting portion 115 and the second engagement means 175 of the sensor holder 110 may be any known engagement means used to form a process connection, such as for example, threaded connections, flange connections, compression connections, adhesive connections, and “quick-connect” couplings. As shown in FIG. 3a, for example, the connecting portion 115 may comprise a threaded portion 135 for engaging an oppositely-gendered threaded portion 175 of the sensor holder 110. Although the threaded portion 135 is depicted as comprising male threads formed on the external wall 125 of the connecting portion 115, it may be appreciated that the threaded portion 135 may alternatively comprise female threads formed on the inside wall 120 of the connecting portion 115. The external diameter of the connecting portion 115, as defined by the external wall 125, and the thread size of the threaded portion 135 may be any suitable diameter and thread size combination such as, for example, 0.6 inches and M16×1 mm, respectively. Although not necessary, the connecting portion 115 may be fabricated from a material identical to that of the sensor housing 20 such as, for example, a thermoplastic material or metal, such as stainless steel. According to various embodiments, the connecting portion 115 and the sensor housing 20 may be formed separately or as a single unit through processes such as, for example, pouring or injection molding.

According to various embodiments, the gasket 140 may extend from a second surface on the rim portion 75 of the sensor housing 20 and be centrally positioned relative to the external wall 55. The gasket 140 may be, for example, an O-ring gasket sized such that the external diameter of the connecting portion 115 may be coaxially received through an internal diameter defined by the gasket 140. The gasket 140 may be fabricated from any suitably pliable material, such as, for example, an elastomer material, for providing a gas-tight seal when compressed between two opposing surfaces. The gasket 140 may be retained on the rim portion 75 by frictional contact between the internal diameter of the gasket 140 and the external wall 125 of the connecting portion 115.

The electrical connector 145 may be mounted to the circuit board 65 and be any electrical connector suitable for communicating a current signal from the contact rings 70a-b of the trace oxygen sensor 105 to a conductor pair (not shown) attached thereto. The conductor pair may be connected to a sensing circuit (not shown). According to various embodiments, for example, the electrical connector 145 may be a female RJ-type electrical connector for receiving a corresponding male end of a two-conductor shielded cable connected to the sensing circuit. Examples of other suitable types of electrical connectors include coaxial electrical connectors, terminal block/strip electrical connectors, and banana plug electrical connectors.

According to various embodiments, the sensor holder 110 may have an open-ended cylindrical geometry and comprise generally coaxial internal and external walls 150, 155, respectively, and generally parallel internal and external bottom surfaces 160, 165, respectively. The sensor holder 110 may be fabricated from materials such as, for example, thermoplastic materials or metal, such as stainless steel. The internal wall 150 of the sensor holder 110 may define a cylindrically-shaped receiving portion 170 centrally positioned relative to the external wall 155. The sensor holder 110 may comprise a second means 175 for removably engaging the corresponding first engagement means 135 of the connecting portion 115 such that such the connecting portion 115 is received into the receiving portion 170. As noted above, the second engagement means 175 of the sensor holder 110 and the first engagement means 135 of the connecting portion 115 may be any known engagement means used for establishing a process connection, but may, as shown in FIGS. 3a and 3b, comprise threads. As shown in FIG. 3a, for example, the internal wall 150 of the sensor holder 110 may comprise a female threaded portion 175 for removably engaging the male threads of the threaded portion 135 of the connecting portion 115. According to such embodiments, the connecting portion 115 may be received into the receiving portion 170 by axially aligning the connecting portion 115 with the receiving portion 170 and rotating the trace oxygen sensor 105 in a direction so as to engage the threaded portions 135, 175. The threaded portions 135, 175 maybe sized such that their continual engagement causes the gasket 140 to be compressed between the rim portion 75 of the sensor housing 20 and an opposing rim portion 180 of the sensor holder 110. Alternatively, a seal may be made by covering the threaded portions 135, 175 with a sealing tape or a sealing grease. It may be appreciated that the gasket 140 in above-described embodiments may alternatively be retained on the rim portion 180 of the sensor holder 110 instead of the rim portion 75 of the sensor housing 20.

The sensor holder 110 may further comprise a gas supply inlet 185 for receiving a gas stream to be sensed into the sensor holder 110 and for introducing the received gas stream into the passageway 130 of the connecting portion 115 via the receiving portion 170. The sensor holder 110 may further comprise a gas supply outlet 190 for receiving the sensed gas stream from the passageway 130 of the connecting portion 115 via the receiving portion 170 and for exhausting the sensed gas stream out of the sensor holder 110. According to various embodiments, the gas supply inlet 185 and the gas supply outlet 190 may comprise passageways 195, 200, respectively, that connect corresponding apertures in the external wall 155 of the sensor holder 110 to the receiving portion 170. The passageways 195, 200 may be positioned between the internal and external bottom surfaces 160, 165 of the sensor holder 110 and connect to the receiving portion 170 through a common aperture 205 defined by the internal bottom surface 160.

As can be seen in the embodiments of FIGS. 3a and 3b, because the sensor holder 110 is not required to encapsulate the trace oxygen sensor 105, the sensor holder 110 requires substantially less material than the sensor canister 80 used in conventional trace oxygen analyzers. Accordingly, the manufacturing cost of a trace oxygen analyzer incorporating embodiments of the sensor assembly 102 may be correspondingly reduced. Manufacturing costs may be further reduced by providing a user of the trace oxygen analyzer with an option to fabricate the sensor holder 110 using their own tools, materials and labor resources. Fabrication by the user may be performed using standard machining equipment based on measurements provided by the manufacturer of the trace oxygen analyzer.

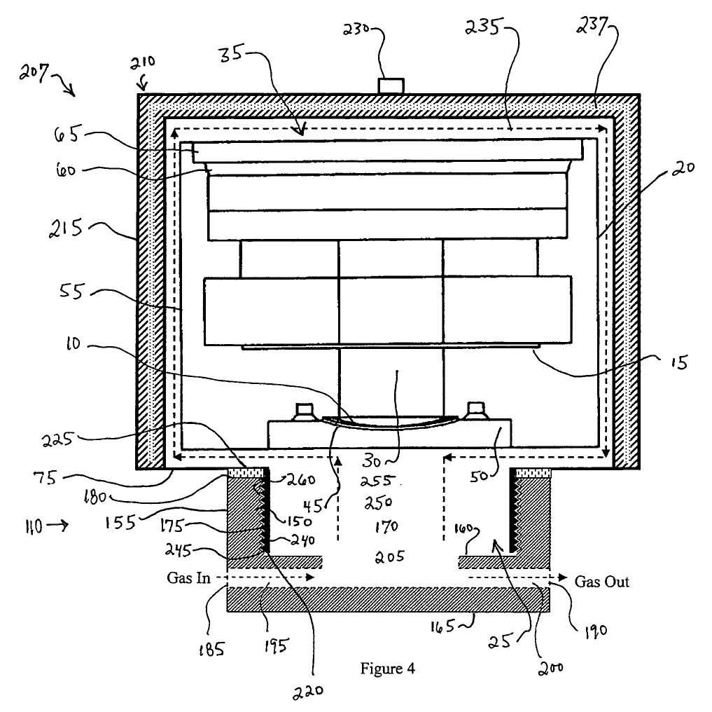

FIG. 4 illustrates a cross-sectional view of a gas sensor assembly 207, according to various embodiments. The sensor assembly 207 may comprise a trace oxygen sensor 210 having features and sensing capabilities such as those of the sensor 5 described above in connection with FIGS. 1a, 1b, and 1c. The trace oxygen sensor 210 may comprise a sensor housing 20, an integral gas exposure housing 215, a connecting portion 220 attached to the gas exposure housing 215, a gasket 225, and an electrical connector 230. The sensor assembly 207 may further comprise a connecting-type sensor holder 110 such as described above in connection with FIGS. 3a and 3b for removably engaging a portion of the trace oxygen sensor 210.

The gas exposure housing 215 may be attached to the sensor housing 20 of the trace oxygen sensor 210 and be of a size and geometry suitable for encapsulating the sensor housing 20 such that the gas exposure housing 215 and the sensor housing 20 define a circulation cavity 235 therebetween. According to various embodiments, the gas exposure housing 215 may have a geometry similar to, but larger than, that defined by the sensor housing 20 and positioned such that the circulation cavity 235 is symmetrically defined throughout. The gas exposure housing 215 may be fabricated from any resilient insulating material such as, for example, a thermoplastic material.

According to various embodiments, the gas exposure housing 215 may comprise an insulation jacket 237 for insulating the trace oxygen sensor 210 from external temperature fluctuations. As shown in FIG. 4, the insulation jacket 237 may comprise a volume of a gas sealably contained within the gas exposure housing 215. Preferably, the gas has a relatively low value of thermal conductivity, such as, for example, argon, although any gas or gas mixture (e.g., air, nitrogen) may also be used. Alternatively, the insulation jacket 237 may comprise one or more layers of a material having suitable insulative properties. According to such embodiments, the insulation jacket 237 may be contained within the gas exposure housing 215 or attached to a surface thereof.

According to various embodiments, the connecting portion 220 may be identical to connecting portion 115 of the sensor 5 described above in terms of geometry, size, and features. For example, the connecting portion 220 may have a cylindrical geometry and comprise generally coaxial internal and external walls 240, 245, respectively. The connecting portion 220 may be centrally positioned on an external surface of the gas exposure housing 215 adjacent to the first end 25 and extend outward in a perpendicular fashion therefrom. The internal wall 240 of the connecting portion 220 may define a passageway 250 axially aligned with the first opening 30 and connected to the first opening 30 and circulation cavity 235 via an aperture 255 defined by the gas exposure housing 215. The connecting portion 220 may comprise a first engagement means 260 for removably engaging a second engagement means 175 of the sensor holder 110. The first and second engagement means 260, 175 may be any known engagement means that may be used to form a process connection. According to various embodiments, for example, the first engagement means 260 may be similar to that described above with respect to connecting portion 115.

According to various embodiments, the gasket 225 may be identical to the gasket 140 of the sensor 5 described above in terms of geometry, size, and features. The gasket 225 may be, for example, an O-ring gasket sized such that the external diameter of the connecting portion 220 may be coaxially received through an internal diameter defined by the gasket 225. The gasket 225 may be retained on an external surface of the gas exposure housing 215 adjacent to the first end 25 of the sensor housing 20 by frictional contact between the internal diameter of the gasket 225 and the external wall 245 of the connecting portion 220. The threaded portions 175, 260 may be sized such that their continual engagement causes the gasket 225 to be compressed between the external surface of the gas exposure housing 215 and the opposing rim portion 180 of the sensor holder 110 in a manner similar to that described in connection with FIGS. 3a and 3b.

According to various embodiments, the electrical connector 230 may be any electrical connector suitable for communicating a current signal from the contact rings 70a-b of the trace oxygen sensor 210 to a conductor pair (not shown) attached thereto. For example, the electrical connector 230 may be a female RJ-type electrical connector for receiving a corresponding male end of a two-conductor shielded cable connected to a sensing circuit. Examples of other suitable types of electrical connectors include coaxial electrical connectors, terminal block/strip electrical connectors, and banana plug electrical connectors. The electrical connector 230 may be mounted on the external surface of the gas exposure housing 215 adjacent to the second end 35 thereof and electrically connected to the contact rings 70a-b via corresponding leads (not shown) that sealably enter the gas exposure housing 215.

During operation, a gas stream received into the sensor holder 110 through the gas supply inlet 185 may be introduced into the passageway 250 of the connecting portion 220 via aperture 255 and the receiving portion 170. From the passageway 250, a portion of the gas stream may be introduced into the first opening 30 via the sensing membrane 45. The remaining portion of the gas stream may be introduced into the circulation cavity 235 and circulated therethrough. Both portions of the gas stream may then be received into the gas supply outlet 190 via the passageway 250, and the receiving portion 170, and the aperture 255, whereupon the portions are exhausted from the sensor holder 110.

The insulative properties of the gas exposure housing 215 and the circulation of a portion of the gas stream through the circulation cavity 235 enhance the thermal stability of the trace oxygen sensor 210 and decrease the adverse effects of external temperature fluctuations upon its operation. Additionally, in the event that caustic electrolyte solution contained in the trace oxygen sensor 210 is leaked through the sensor housing 20 during handling or operation, the gas exposure housing 210 may serve to contain the leaked solution, thus reducing the risk of injury to personnel or damage to equipment.

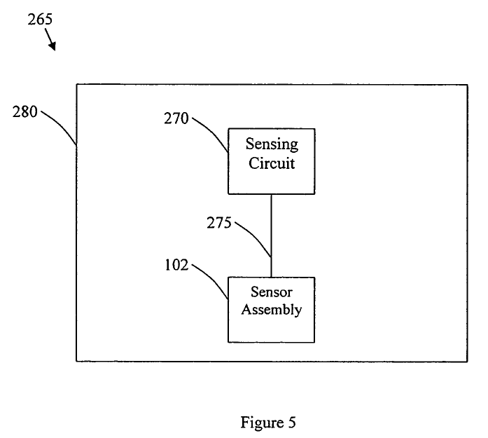

FIG. 5 illustrates a schematic diagram of trace oxygen analyzer 265 comprising the sensor assembly 102 described above in connection with FIGS. 3a and 3b, according to various embodiments. According to other embodiments, the trace oxygen analyzer 265 may alternatively comprise the sensor assembly 207 discussed above in connection with FIG. 4. The analyzer 265 may further comprise a sensing circuit 270 connected to the sensor assembly 102 via conductor pair 275 and an enclosure 280 housing the sensor assembly 102, sensing circuit 270, and conductor pair 275.

As discussed above, the sensor assembly 102 may generate a current signal used to derive the concentration of oxygen contained in a sensed gas stream. The current signal may be communicated from the electrical connector 145 of the sensor assembly 102 to the sensing circuit 270 via the conductor pair 275. The conductor pair 275 may be, for example, a shielded conductor pair having an end configured for mating with the electrical connector 145.

The sensing circuit 270 may be any known sensing circuit typically used in trace oxygen analyzers for converting the current signal received from the sensor assembly 102 into an oxygen concentration output. According to various embodiments, the sensing circuit 270 may include one or more microprocessors, signal processors, power supplies, data input devices, and display devices for implementing the conversion and for outputting the corresponding result. Additionally, the sensing circuit 270 may include one or more outputs for controlling one or more solenoid-operated flow control valves. The flow control valves may be operated such that the sensed gas stream and zero and span calibration gas streams are introduced to the sensor assembly 102 in the appropriate manner.

The enclosure 280 may be any type of known enclosure suitable for housing the sensor assembly 102, sensing circuit 270, and cable 275 and for accommodating process lines and control valves necessary for the delivery and exhaust of the sensed and calibration gas streams. Although the sensor assembly 102 is shown in FIG. 5 as being contained in the enclosure 280, it will be appreciated that in other embodiments the sensor assembly 102 may be externally located with respect to the enclosure 280.

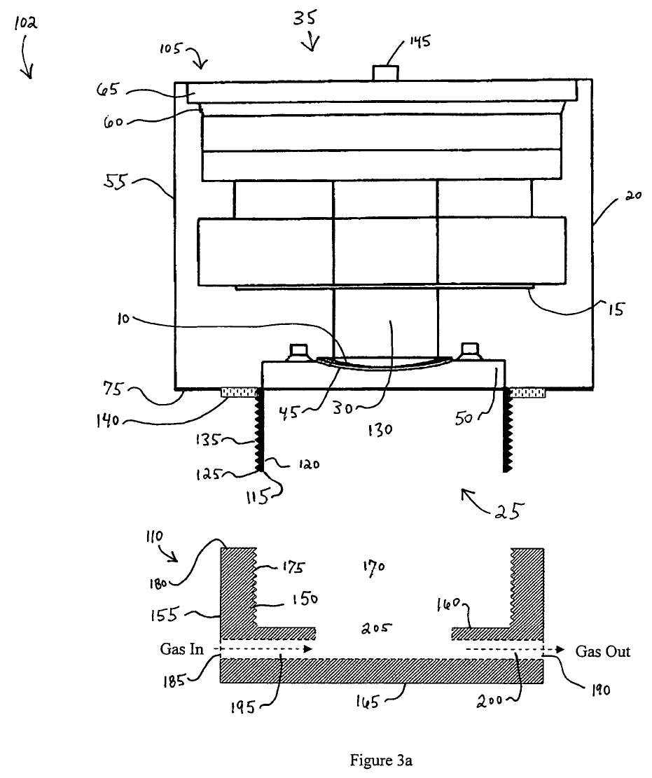

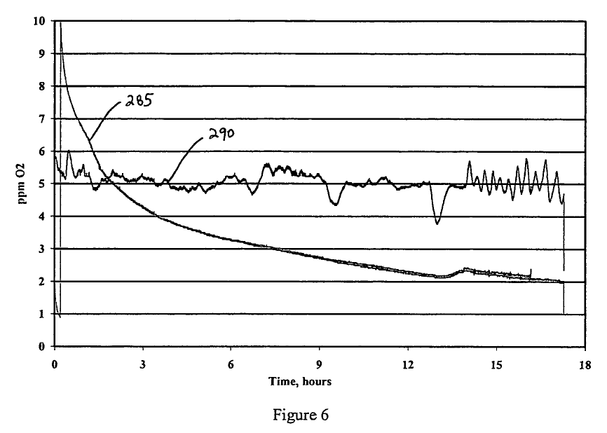

FIG. 6 illustrates a first oxygen concentration trendline 285 comprising data obtained by sensing a first gas stream having a known oxygen concentration over a period of time using a first trace oxygen analyzer of a conventional design. The first trace oxygen analyzer comprised a conventional sensor 5 and sensor canister 80 as described above in connection with FIGS. 1a, 1b, and 1c and FIG. 2. FIG. 6 further illustrates a second oxygen concentration trendline 290 comprising data obtained by sensing a second gas stream having an oxygen concentration identical to that of the first gas stream over the same time period using a second trace oxygen analyzer comprising an embodiment of the sensor assembly 102 of FIGS. 3a and 3a. Both oxygen analyzers used components commercially available from Teledyne Analytical Instruments, and, with the exception of the sensor assembly 102, were identically configured. The sensor 5 used in the first trace oxygen analyzer was a Teledyne Model B-2C trace oxygen sensor. The sensor assembly 102 of the second trace oxygen analyzer comprised components of a Model B-2C sensor modified for use therein.

As shown in FIG. 6, the first trendline 285 demonstrates a gradual decline in oxygen concentration over time due to sensor normalization. After approximately 12-15 hours, the sensor 5 has normalized and the first trendline 285 indicates an oxygen concentration of approximately 2 ppm. The second trendline 290 does not exhibit a decline due to normalization, as the sensor assembly 102 of the second trace oxygen analyzer was exposed to the second gas stream prior to data collection. The second trendline 290 indicates an average oxygen concentration of approximately 5 ppm. Although some fluctuation in the data values of the second trendline 290 due to thermal instability is apparent, the magnitude of the fluctuation is nonetheless acceptable in sensing applications having less stringent lower detectable limit (LDL) requirements. Furthermore, in such sensing applications, the offset of approximately 3 ppm observed in the oxygen concentration of the second trendline 290 when compared to that of the first trendline 285 is tolerable and, if necessary, may be compensated for using known signal processing techniques.

The above-described results obtained using the sensor assembly 102 in a trace oxygen analyzer are unexpected given the prevailing view among those skilled in the art that a sensor canister 80 is necessary in order to realize acceptable levels of thermal stability and ambient oxygen ingress in a trace oxygen analyzer comprising a conventional trace oxygen sensor.

Whereas particular embodiments of the invention have been described herein for the purpose of illustrating the invention and not for the purpose of limiting the same, it will be appreciated by those of ordinary skill in the art that numerous variations of the details, materials, configurations and arrangement of components may be made within the principle and scope of the invention without departing from the spirit of the invention. The preceding description, therefore, is not meant to limit the scope of the invention.

1. A gas sensor assembly comprising:
a trace oxygen sensor, the sensor comprising:
a sensor housing; and
a connecting portion attached to the sensor housing and defining a passageway for introducing a gas stream to the sensor housing.

2. The gas sensor assembly of claim 1, wherein the connecting portion comprises first means for engaging.

3. The gas sensor assembly of claim 2, further comprising:
a holder, the holder comprising:
a receiving portion;
second means for removably engaging the first engagement means of the connecting portion of the sensor such that the connecting portion is received into the receiving portion;
a gas supply inlet for receiving the gas stream into the holder and for introducing the gas stream into the passageway of the connecting portion via the receiving portion; and
a gas supply outlet for receiving the gas stream from the passageway of the connecting portion via the receiving portion and for exhausting the gas stream out of the holder.

4. The gas sensor assembly of claim 3, wherein the first engagement means comprises a first threaded portion and wherein the second engagement means comprises a second threaded portion having a gender opposite to that of the first threaded portion.

5. The gas sensor assembly of claim 3, wherein one of the sensor and the holder comprises a gasket for forming a gas-tight seal between the sensor and the holder during engagement of the first and second engagement means.

6. The gas sensor assembly of claim 1, wherein the sensor further comprises an electrical connector adapted for communicating a current signal from the sensor to a conductor pair attached thereto.

7. A gas sensor assembly comprising:
a trace oxygen sensor, the sensor comprising:
a sensor housing;
a gas exposure housing encapsulating the sensor housing, the gas exposure housing and sensor housing defining a circulation cavity therebetween; and
a connecting portion attached to the gas exposure housing and defining a passageway for introducing a gas stream to the circulation cavity and to the sensor housing.

8. The gas sensor assembly of claim 7, wherein the connecting portion comprises first means for engaging.

9. The gas sensor assembly of claim 8, further comprising:
a holder, the holder comprising:
a receiving portion;
second means for removably engaging the first engagement means of the connecting portion of the sensor such that the connecting portion is received into the receiving portion;
a gas supply inlet for receiving the gas stream into the holder and for introducing the gas stream into the passageway of the connecting portion via the receiving portion; and
a gas supply outlet for receiving the gas stream from the passageway of the connecting portion via the receiving portion and for exhausting the gas stream out of the holder.

10. The gas sensor assembly of claim 9, wherein the first engagement means comprises a first threaded portion and wherein the second engagement means comprises a second threaded portion having a gender opposite to that of the first threaded portion.

11. The gas sensor assembly of claim 7, wherein the gas exposure housing comprises an insulation jacket for insulating the sensor from temperature fluctuations.

12. The gas sensor assembly of claim 1 1, wherein the insulation jacket comprises a volume of a gas sealed within the gas exposure housing.

13. The gas sensor assembly of claim 11, wherein the insulation jacket comprises a non-gas insulation jacket.

14. The gas sensor assembly of claim 9, wherein one of the sensor and the holder comprises a gasket for forming a gas-tight seal between the sensor and the holder during engagement of the first and second engagement means.

15. The gas sensor assembly of claim 7, wherein the sensor further comprises an electrical connector adapted for communicating a current signal from the sensor to a conductor pair attached thereto.

16. A trace oxygen analyzer for sensing a trace oxygen concentration in a gas stream, the analyzer comprising:
a trace oxygen sensor, the sensor comprising:
a sensor housing;
a connecting portion attached to the sensor housing and defining a passageway for introducing a gas stream to the sensor housing; and
an electrical connector adapted for communicating a current signal from the sensor to a conductor pair attached thereto; and
a sensing circuit for receiving the current signal from the sensor via the conductor pair and for converting the received current signal into an oxygen concentration output.

17. The trace oxygen analyzer of claim 16, wherein the connecting portion comprises first means for engaging.

18. The trace oxygen analyzer of claim 17, further comprising:
a holder, the holder comprising:
a receiving portion;
second means for removably engaging the first engagement means of the connecting portion of the sensor such that the connecting portion is received into the receiving portion;
a gas supply inlet for receiving the gas stream into the holder and for introducing the gas stream into the passageway of the connecting portion via the receiving portion; and
a gas supply outlet for receiving the gas stream from the passageway of the connecting portion via the receiving portion and for exhausting the gas stream out of the holder.

19. The trace oxygen analyzer of claim 18, wherein the first engagement means comprises a first threaded portion and wherein the second engagement means comprises a second threaded portion having a gender opposite to that of the first threaded portion.

20. The trace oxygen analyzer of claim 18, wherein one of the sensor and the holder comprises a gasket for forming a gas-tight seal between the sensor and the holder during engagement of the first and second engagement means.

21. A trace oxygen analyzer for sensing a trace oxygen concentration in a gas stream, the analyzer comprising:
a trace oxygen sensor, the sensor comprising:
a sensor housing;
a gas exposure housing encapsulating the sensor housing, the gas exposure housing and sensor housing defining a circulation cavity therebetween;
a connecting portion attached to the gas exposure housing and defining a passageway for introducing a gas stream to the circulation cavity and to the sensor housing; and
an electrical connector adapted for communicating a current signal from the sensor to a conductor pair attached thereto; and
a sensing circuit for receiving the current signal from the sensor via the conductor pair and for converting the received current signal into an oxygen concentration output.

22. The trace oxygen analyzer of claim 21, wherein the connecting portion comprises first means for engaging.

23. The trace oxygen analyzer of claim 22, further comprising:
a holder, the holder comprising:
a receiving portion;
second means for removably engaging the first engagement means of the connecting portion of the sensor such that the connecting portion is received into the receiving portion;
a gas supply inlet for receiving the gas stream into the holder and for introducing the gas stream into the passageway of the connecting portion via the receiving portion; and
a gas supply outlet for receiving the gas stream from the passageway of the connecting portion via the receiving portion and for exhausting the gas stream out of the holder.

24. The trace oxygen analyzer of claim 23, wherein the first engagement means comprises a first threaded portion and wherein the second engagement means comprises a second threaded portion having a gender opposite to that of the first threaded portion.

25. The gas sensor assembly of claim 21, wherein the gas exposure housing comprises an insulation jacket for insulating the sensor from temperature fluctuations.

26. The gas sensor assembly of claim 25, wherein the insulation jacket comprises a volume of a gas sealed within the gas exposure housing.

27. The gas sensor assembly of claim 25, wherein the insulation jacket comprises a non-gas insulation jacket.

28. The trace oxygen analyzer of claim 23, wherein one of the sensor and the holder comprises a gasket for forming a gas-tight seal between the sensor and the holder during engagement of the first and second engagement means.

29. The gas sensor assembly of claim 1, wherein the connecting portion comprises one of a threaded connection, a flange connection, a compression connection, an adhesive connection, and a quick-connect coupling.

30. The gas sensor assembly of claim 7, wherein the connecting portion comprises one of a threaded connection, a flange connection, a compression connection, an adhesive connection, and a quick-connect coupling.
